(19) United States
(12) Patent Application Publication
(10) Pub. No.: US 2017/0245512 A1
(43) Pub. Date: Aug. 31, 2017

(54) STRAWBERRY DRIED PRODUCT HAVING HIGH SOD ENZYME ACTIVITIES AND PREPARATION METHOD THEREFOR

(71) Applicant: ZHONGKE YUN HEALTH SCIENCE & TECHNOLOGY (TIANJIN) CO., LTD., Tianjin (CN)

(72) Inventors: Yun Li, Tianjin (CN); Kai Sun, Tianjin (CN)

(21) Appl. No.: 15/464,615

(22) Filed: Mar. 21, 2017

Related U.S. Application Data
(63) Continuation of application No. 14/380,763, filed on Dec. 15, 2014, now abandoned.

(30) Foreign Application Priority Data
Feb. 24, 2012 (CN) 201210044907.9
Feb. 22, 2013 (CN) 201310057404.X

(51) Int. Cl. A23B 7/024

(52) U.S. Cl. CPC A23B 7/024; A23V 2002/00

(57) ABSTRACT

A strawberry dried product exhibiting high SOD enzyme activities and a preparation method therefor. The strawberry dried product maintains the maximum degree of the original shape, color, smell, and taste of fresh strawberries, that has nutrients such as vitamins, anthocyanin, and multiple amino acids, and exhibits high SOD enzyme activities. The drying method enhances the preserved freshness of fresh strawberries, and provides cooling the fresh strawberries in an average dropping temperature of 20° C. or more per minute to form amorphous ice, and sublimating the amorphous ice to obtain the strawberry dried product.

### CROSS-REFERENCE TO RELATED APPLICATIONS

This application is a continuation of U.S. application Ser. No. 14/380,763, filed Dec. 15, 2014, which is the US National Stage of International Application No. PCT/CN2013/071858, filed Feb. 25, 2013, the disclosures of which are incorporated herein by reference in their entirety.

### TECHNICAL FIELD

The present application relates to a dried strawberry product having high SOD enzyme activities and a method for the preparation of a dried strawberry product having high SOD enzyme activities.

### BACKGROUND ART

After the fresh vegetables and fruits are dried, the dehydrated ones become easy to store, convenient to carry and easy to eat.

The method for drying the vegetables and fruits goes through the process of drying in cool places, drying in the sun, stoving, baking and drying in far infrared oven. After all of the process, the dried vegetables and fruits lose their original color; become black, wrinkle and uneven; and lose their nutritional ingredients.

The present drying methods include Vacuum Drying, Vacuum Freeze Drying, and Freeze Drying (referred to as FD technique). The FD technique is the drying and dehydrating technique of combining the freeze technique and vacuum technique together. This technique uses the heat and mass transfer mechanism of the low temperature and pressure. The material to be dried is frozen in the environment where the temperature is lower than the material eutectic point. For example, the material is frozen in the temperature of −10° C.˜−50° C. to transfer the water in the material into crystal ice; and then the material is disposed in a high vacuum environment to sublimate the crystal ice formed in the previous process into gas and thereby the moisture inside the material is removed. But the FD technique takes a long period of time. And to transfer the moisture inside the food into crystal ice is highly cost and lowly economical beneficial and consumes great sum of electricity and energy.

### SUMMARY OF THE INVENTION

Strawberry is red and in heart shape. It is fresh, delicious, juicy, sour-sweet and fragrant. It has not only a colorful appearance, but also a special kind of intoxicating fragrance which does not exist in other fruits. Because of its excellent appearance, special fragrance and wonderful taste, this precious fruit is called “Queen of Fruits”. Moreover, strawberry is nutritious containing a great number of elements like protein, multiple amino acids and trace elements. In addition, the researches in recent years reveal that strawberry has high SOD enzyme activity and contains a component of anthocyanin, and that it possesses notable anti-oxidation function.

Strawberry is rich of active components such as phenolic acid, polyphenol, anthocyanin and flavonoids, possesses strong ability of anti-oxidizing and scavenging free radical, is able to nourish the gastrointestinal tract and skin and produces good preventing and therapeutic effects for arteriosclerosis and coronary heart disease (TULIPANIS, MESSETTI B, CAPOCASA F. Antioxidants, phenolic compounds, and nutritional quality of different strawberry genotypes [J]. Journal of Agricultural and Food Chemistry, 2008, 56(3): 696-704). Strawberry is a fruit rich of anti-oxidative substance, having an anti-oxidative ability 2-11 times of other gardening products such as apple, peach, pear, potato, orange and kiwifruit (WANG Hong, CAO Guohua, PRIOR R L. Total antioxidant capacity of fruits [J]. Journal Agricultural Food Chemistry, 1996, 44: 701-705). Phenolics are capable of reducing or scavenging oxidative free radicals, effectively inhibiting active oxidative free radicals and enhancing immune of the body through regulating the cellular oxidative-reductive state so as to reduce the injury of the body and occurrence of diseases (HUANG Wuyang, CAI Yizhong, ZHANG Yanbo, Natural Phenolic compounds from medicinal herbs and dietary plants: potential use for cancer prevention [J]. Nutrition and Cancer, 2009, 62(1): 1-20).

Strawberry is an instant fresh food, which is not only early on the market, flavorful, and nutritious, but also an ideal feedstock with good processing adaptability. At present, besides selling fresh in domestic market and exporting in freeze, there appear multiple forms of fabricated products taking strawberry as feedstock. But as the growth of the strawberry is limited by seasons and regions, the fresh strawberry cannot always be available. In conclusion, strawberry has an extraordinarily high deep-processing and developing value.

Since strawberry is rich of multiple nutritional components, especially the anti-oxidative component represented by the one exhibiting SOD enzyme activity, a dried strawberry product maintaining the original shape, flavor and the nutritional components cannot be obtained through the traditional drying technique.

The present invention provides a dried strawberry product which is substantially capable of maintaining the original components like the shape, color, taste, flavor and anthocyanin of fresh strawberry and exhibiting high SOD enzyme activity.

In the first aspect, the present invention provides a dried strawberry product which is substantially free of moisture, has a substantially original internal cellular frame and exhibits a sponge appearance.

The dried strawberry product has a maximum radial dimension of 0.1˜10 cm, preferably 0.5˜8 cm and has multiple forms, such as strawberry block, strawberry dice, strawberry piece and strawberry particle. Such a maximum radial dimension refers to the maximum size in all directions of the final strawberry product maintained throughout the producing process. Upon the specific requirement, the dried strawberry product can also be cut into desirable size.

In one embodiment of the first aspect, the dried strawberry product provided in the present invention is strawberry block, which has a maximum radial dimension of 0.1˜10 cm, preferably 0.5˜8 cm.

The dried strawberry product provided according to another aspect of the present invention is a product prepared by cooling fresh strawberry at a rate of greater than 20° C., preferably greater than 30° C. more preferably greater than 40° C., more preferably greater than 60° C., and more preferably greater than 90° C., per minute, and further sublimating.

The dried strawberry product is provided according to another aspect of the present invention, wherein the fresh strawberry is subjected to a physical treatment.

The dried strawberry product is provided according to another aspect of the present invention, wherein the color/morphology of the dried strawberry product has a maintenance degree (color/shape retention index) above 7.0, where the maintenance degree of the color/morphology of the dried strawberry product is determined by evaluation based on sensory analysis test on the basis that fresh strawberry's color/morphology is set to 10.

The dried strawberry product is provided according to another aspect of the present invention, wherein the dried strawberry product has a smell maintenance degree above 7.0, wherein the smell maintenance degree (flavor retention index) of the dried strawberry product is determined by evaluation based on sensory analysis test on the basis that fresh strawberry's smell is set to 10.

The dried strawberry product is provided according to another aspect of the present invention, wherein the dried strawberry product has a taste preference above 8.0, where the taste preference of the dried strawberry product is determined by evaluation based on sensory analysis test on the basis that fresh strawberry has a taste preference which is set to 10.

The dried strawberry product is provided according to another aspect of the present invention, wherein the color/morphology of the dried strawberry product has a maintenance degree at least 1.0 greater than that prepared by using the traditional freezing method,

The dried strawberry product is provided according to another aspect of the present invention, wherein the dried strawberry product has a smell maintenance degree of at least 2.0 greater than that prepared by using the traditional freezing method.

The dried strawberry product is provided according to another aspect of the present invention, wherein the dried strawberry product has a taste preference of at least 0.4 greater than that prepared by using the traditional freezing method.

The dried strawberry product is provided according to another aspect of the present invention, wherein the dried strawberry product has a sponge—like structure and is capable of absorbing water, where water enters the sponge network of the dried strawberry product and when it is fulfilled with moisture, the strawberry achieves a state of full of water and has an appearance similar to fresh strawberry.

The dried strawberry product is provided according to another aspect of the present invention, wherein the dried strawberry product is substantially free of moisture, i.e., it contains water in a content of lower than 5 wt %, preferably lower than 4 wt % more preferably lower than 3 wt %, and most preferably lower than 2.5 wt %.

The dried strawberry product is provided according to another aspect of the present invention, wherein the SOD enzyme activity of the dried strawberry product is increased greater than 80%, preferably greater than 100%, comparing the SOD enzyme activity exhibited by the dried strawberry product U2 (calculated on a dry weight basis) to the SOD enzyme activity exhibited by the feedstock for preparing the same (calculated on a dry weight basis).

The dried strawberry product is provided according to another aspect of the present invention, wherein the dried strawberry product exhibits an SOD enzyme activity U2 greater than 650 U/g of strawberry (calculated on a dry weight basis), preferably greater than 800 U/g of strawberry (calculated on a dry weight basis), more preferably greater than 900 U/g of strawberry (calculated on a dry weight basis), further more preferably greater than 1000 U/g of strawberry (calculated on a dry weight basis), and most preferably greater than 1200 U/g of strawberry (calculated on a dry weight basis)

The SOD enzyme activity referred in the present invention can be detected by using the methods listed in the examples, wherein the unit of the SOD enzyme activity, U represents that: at room temperature (usually 25° C.), the amount of enzyme that is capable of transferring 1 μmol substrate is called 1 enzyme unit (U). The SOD enzyme activity represented by U/g refers to the total SOD enzyme activity exhibited by the substance which exhibits SOD enzyme activity of the dried strawberry product per gram (calculated on a dry weight basis).

The dried strawberry product is provided according to another aspect of the present invention, wherein the content of anthocyanin in the dried strawberry product (calculated on a dry weight basis) is above 2.0 g/kg of strawberry, preferably above 2.4 g/kg of strawberry.

The dried strawberry product is provided according to another aspect of the present invention, wherein the dried strawberry product has hardness lower than that prepared by a traditional method, where the hardness is detected by using the Shore Hardness Tester as described hereinafter. In an embodiment, the dried strawberry product provided according to the present invention has hardness of 12-18 by using the Shore Hardness Tester.

The dried strawberry product is provided according to another aspect of the present invention, wherein the dried strawberry product has an outer surface color (tone) higher than the fresh strawberry feedstock for preparing the same. In a specific embodiment the outer surface has a value of 7626-7627 measured by color cards (PANTONE Colors atla).

The dried strawberry product provided according to another aspect of the present invention has a rate of water absorption of 3.58.

In the second aspect, the present invention provides a preparation method for the dried strawberry product provided in the first aspect of the present invention, wherein the method comprises the following steps:
a. providing fresh strawberry;
b. cooling fresh strawberry at a rate of greater than 20° C., preferably greater than 30° C., more preferably greater than 40° C., more preferably greater than 60° C., more preferably greater than 90° C., per minute, and,
c. sublimating the strawberry which is subjected to step b.

The preparation method for the dried strawberry product is provided in the second aspect of the present invention, wherein step b is carried out by using liquid nitrogen, such as immersing fresh strawberry dice/slices into liquid nitrogen or spraying liquid nitrogen on the surface of fresh strawberry dice/slices. After cooling, strawberry exhibiting a freezing state is obtained. Specifically, the strawberry exhibiting a freezing state means freezing strawberry of which water inside the fresh strawberry is frozen into glassy ice (not crystal ice).

The preparation method for the dried strawberry product is provided in the second aspect of the present invention wherein step c is performed under a vacuum condition, preferably performed by warming up under a vacuum condition or continuously vacuum pumping.

The preparation method for the dried strawberry product is provided in the second aspect of the present invention, wherein, prior to step a, the fresh strawberry is subject to physical treatment instead of any chemical treatment, like employing a chemical agent. The so called physical treatment includes slicing and preparing the fresh strawberry into forms of strawberry block, strawberry dice, strawberry slice (piece) and strawberry particles, which are then directly used in the next step.

The preparation method for the dried strawberry product is provided in the second aspect of the present invention, wherein the fresh strawberry block has a maximum radial dimension of 5˜10 cm.

The preparation method for the dried strawberry product is provided in the second aspect of the present invention, wherein the sublimation is performed under a condition of a vacuum degree above 133 Pa, preferably under a condition of a vacuum degree above 133 Pa and below 300 Pa and the vacuum drying step is performed at a temperature of 40˜90° C.

Compared with the dried product produced in the prior art, the dried strawberry product of the present invention and that prepared by using the preparation method therefor can effectively maintain the color, shape and taste of fresh strawberry. It will not turn black, deteriorate, or produce other foreign flavors. And it provides high taste preference. Besides, the nutritional components of the dried strawberry product of the present invention, such as the one exhibiting SOD enzyme activity and the anthocyanin are maintained at high levels. Meanwhile, the preparation method for the dried strawberry product of the present invention can shorten the preparing time and improve the efficiency compared with traditional technique.

### BRIEF DESCRIPTION OF THE DRAWINGS

FIG. 1 illustrates water, crystal ice and glassy ice.

FIG. 2(a) is a photo of the commercial fresh strawberry slices, and (b) is a local enlarged drawing of (a).

FIG. 3(a) is a photo of the dried strawberry product obtained in Example 1 of the present invention, and (b) is a local enlarged drawing of (a).

FIG. 4(a) is a photo of the dried strawberry product obtained in Example 1 upon further hydration test of the present invention, and (b) is a local enlarged drawing of (a).

FIG. 5(a) is a photo of dried strawberry product obtained in Example 2 of the present invention, and (b) is a local enlarged drawing of (a).

FIG. 6(a) is a photo of the dried strawberry product obtained in Example 2 upon further hydration test of the present invention, and (b) is a local enlarged drawing of (a).

FIG. 7 is a photo of the commercial freezing strawberry product in comparative Example 1.

FIG. 8 is a photo of the commercial freezing strawberry product upon further hydration test in comparative Example 1.

FIG. 9(a) is a photo of the strawberry sample obtained by direct drying in comparative Example 2, and (b) is a local enlarged drawing of (a).

FIG. 10(a) is a photo of the strawberry sample obtained by direct drying upon further hydration test in comparative Example 2, and (b) is a local enlarged drawing of (a).

FIG. 11(a) is a photo of the strawberry sample obtained by traditional freezing in comparative Example 3, and (b) is a local enlarged drawing of (a).

FIG. 12(a) is a photo of the strawberry sample obtained by traditional freezing upon further hydration test in comparative Example 3, and (h) is a local enlarged drawing of (a).

FIG. 13 is a photo of the strawberry sample dried in comparative Example 4, and (b) is a local enlarged drawing of (a).

FIG. 14 is a photo of the strawberry sample upon further hydration test dried in comparative Example 4, and (b) is a local enlarged drawing of (a).

FIG. 15 is a photo of the strawberry sample baked in comparative Example 5, and (b) is a local enlarged drawing of (a).

FIG. 16 is a photo of the strawberry sample baked in comparative Example 5 upon further hydration test, and (b) is a local enlarged drawing of (a).

### DETAILED DESCRIPTION OF EMBODIMENTS

Hereinafter, the embodiment of the present invention is specifically illustrated.

If not specially illustrated, the meanings of the terms of the present invention are identical to those widely acknowledged in the art. If there is any difference, the definitions in the present description are employed.

The object of the present invention is to provide a dried food product with high freshness maintaining the original shape, color, flavor, good taste and nutritional components to an utmost extent.

In the first aspect, the present invention provides a dried food product which has a maximum radial dimension of 0.1˜10 cm, preferably 0.5˜8 cm and it is substantially free of moisture, has a substantially complete internal cellular structure and exhibits a sponge appearance,

The dried food product provided according to the first aspect of the present invention is a product prepared by cooling fresh strawberry at a cooling rate of lowering 20° C. or more, preferably 30° C. or more, more preferably 40° C., or more, more preferably 60° C. or more, and more preferably 90° C. or more, per minute, and farther sublimating.

The dried food product is provided according to the first aspect of the present invention, wherein the color/morphology of the dried food product has a maintenance degree above 7.0, where the maintenance degree of the color/morphology of the dried food product is determined by evaluation based on sensory analysis test on the basis that fresh food has color/morphology of 10.

The dried food product is provided according to the first aspect of the present invention, wherein the dried food product has a flavor maintenance degree above 5.0, where the flavor maintenance degree of the dried food product is determined by evaluation based on sensory analysis test on the basis that fresh food has a flavor of 10.

The dried food product is provided according to the first aspect of the present invention, wherein the dried food product has a taste preference above 7.0, where the taste preference of the dried food product is determined by evaluation based on sensory analysis test on the basis that fresh food has a taste preference of 10.

The dried food product is provided according to the first aspect of the present invention, wherein maintenance degree of the color/morphology of the dried food product is at least 0.5 greater than other corresponding dried food products.

The dried food product is provided according to the first aspect of the present invention, wherein the feedstock of the dried food product is fresh vegetables and fruits.

The dried food product is provided according to the first aspect of the present invention, wherein the vegetables and fruits are apples, strawberries, figs and balsam pears.

The dried food product is provided according to the first aspect of the present invention, wherein the dried food product has the ability of absorbing water.

The dried food product is provided according to the first aspect of the present invention, wherein the dried food product can be recovered by immersing in water and absorbing water.

In the second aspect, the present invention provides a preparation method for the dried food product provided according to the first aspect of the present invention, wherein the method comprises the following steps:
a. providing the food feedstock,
b. cooling the food feedstock at a cooling rate of lowering 20° C. or more, preferably 30° C. or more, more preferably 40° C. or more, more preferably 60° C. or more, and more preferably 90° C. or more, per minute, and,
c. sublimating the food feedstock which is subjected to step b.

The preparation method for the dried food product is provided in the second aspect of the present invention, wherein step b is achieved by using liquid nitrogen.

The preparation method for the dried food product is provided in the second aspect of the present invention, wherein step c is performed under a vacuum condition.

[symbol] Dried Strawberry Product

[symbol]

The dried strawberry product is substantially free of moisture, has a substantially complete internal cellular structure, and exhibits a sponge appearance.

The term “substantially free of moisture” refers to that the dried strawberry product contains water in a content of lower than 5 wt %, preferably lower than 4 wt %, more preferably lower than 3 wt %, and more preferably lower than 2.5 wt %. In the present invention, if it is not particularly explained, the values refer to parts by weight.

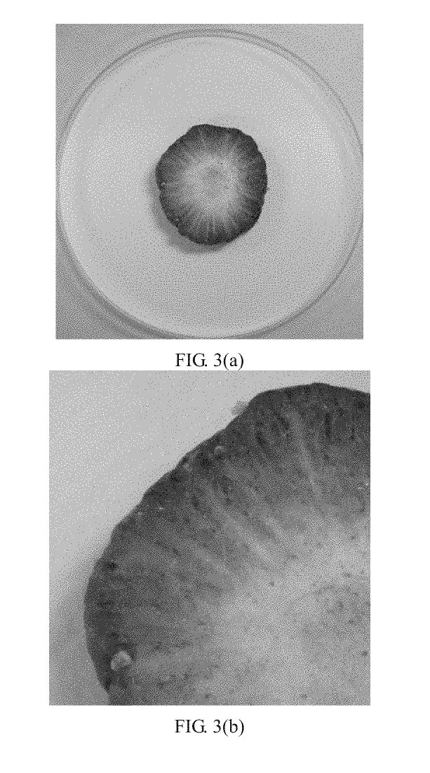

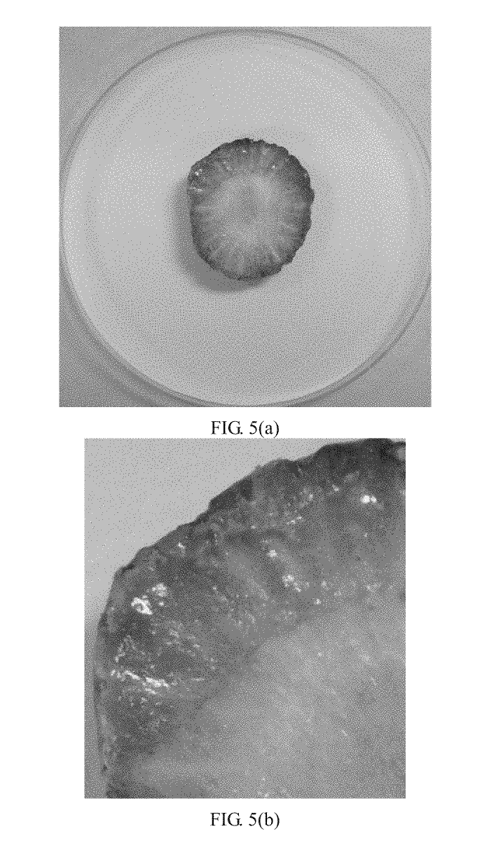

The term that “the dried strawberry product has a substantially complete internal cellular structure and exhibits a sponge appearance” refers to that after the strawberry product is dried, the internal cellular structure of the initial fresh strawberry is not destroyed, but only the inherent moisture is substantially removed, and the whole structure exhibits a sponge appearance. The states of the dried strawberry product in FIGS. 3(a) and 3(b) and FIGS. 5(a) and 5(b) can be referred to.

In the present invention, the specific shape of the dried strawberry product obtained is not particularly defined. It is preferable that it has a maximum radial dimension of 0.1˜10 cm, preferably 0.5˜8 cm, wherein the maximum radial dimension refers to the size of the maximum dimension among those dimensions of the dried strawberry product. For example, for a dried strawberry block product, it refers to the largest sizes in dimensions of length, width, height of a strawberry block. For example, by referring to FIG. 3(a) of the description, the length of the strawberry block is the maximum dimension among those dimensions.

The shape of the dried strawberry product can be particle, piece, block, dice and rod. Generally, the shape of the dried strawberry product is identical to that of the fresh strawberry to be dried obtained by pre-treating fresh strawberry . And the shape thereof can be processed to obtain the desirable shape after the preparation of dried strawberry product.

In a specific embodiment of the present invention, the strawberry block to which slicing treatment is subjected to has a maximum radial dimension of 0.1˜10 cm, preferably 0.5˜8 cm, more preferably 1˜5 cm.

In the present invention, fresh strawberry refers to a strawberry obtained freshly, or strawberry block, strawberry piece, strawberry dice and strawberry particle with a certain shape and size obtained by conducting physical treatment (pre-treatment) for the fresh strawberry feedstock, such as washing, slicing or pelletizing, etc. As mentioned above, the strawberry block and strawberry piece can be obtained by pelletizing or slicing, and the strawberry particle (strawberry dice) with a specific particle size distribution can also be obtained via pelletizing by using a pelletizer. In addition, under normal circumstances, there is no need for the fresh strawberry to be preliminary dried after being washed and drained off the moisture on the surface.

In addition, the fresh strawberry piece, strawberry block, strawberry dice and strawberry particle subjected to physical treatment (pre-treatment) in the present invention does not require chemical treatment with other chemical agent, and the dried product prepared thereby can keep the original color and flavor of the strawberry.

The dried strawberry product in the present invention is a product obtained by cooling the fresh strawberry at a cooling rate of lowering 20° C. or more, preferably 30° C. or more, more preferably 40° C. or more, more preferably 60° C. or more, and more preferably 90° C. or more, per minute, and then treating by vacuum sublimating.

There is no specific limitation to implementation of the above cooling method, all of the methods that can achieve the above average cooling rate can be used for producing the dried strawberry product in the present invention. After cooling, the obtained strawberry in the frozen state is transferred to the apparatus for sublimating, and then the dried strawberry product is obtained after sublimating.

The above steps of cooling and sublimating will be further explained hereinafter.

The dried strawberry product is substantially free of moisture, has a substantially complete internal cellular structure, exhibits a sponge appearance, and has a complete structure substantially the same as the original structure. In the present invention, the internal cellular structure of the dried strawberry product obtained thereby is substantially complete refers to that the internal cellular structure of the dried strawberry product keeps substantially consistent with that of the untreated fresh strawberry, the internal cellular components in the dried strawberry product are substantially intact, with a difference that as compared with the fresh strawberry, the moisture in the cell is removed. Meanwhile, due to the spongy network structure of the dried strawberry product, hardness of the dried strawberry product is lower than other products obtained by the prior art, which renders the dried strawberry product more brittle with a good taste as an edible dried product.

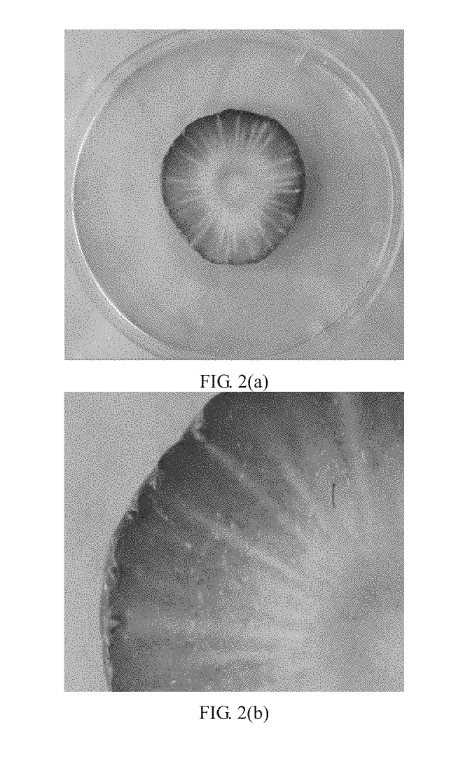

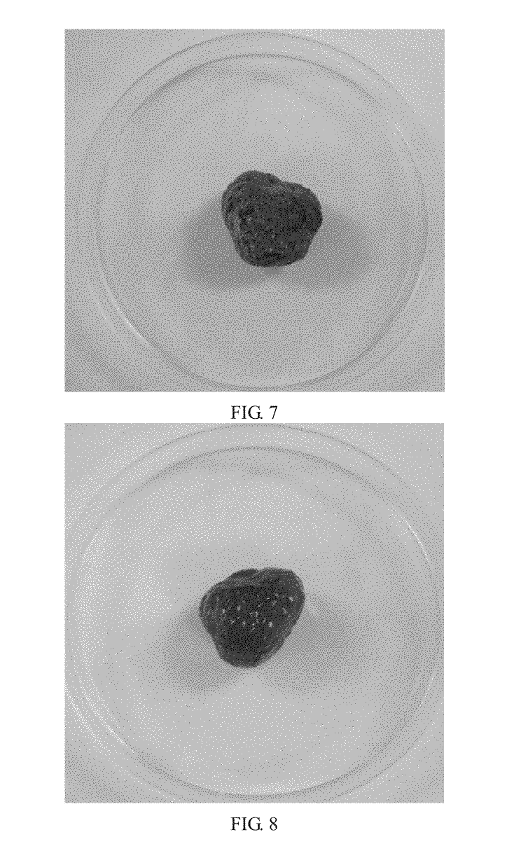

The shape and color of the dried strawberry product are substantially the same as the fresh strawberry, without obvious wrinkles or color change (such as black) due to desiccation. Observed by the naked eye (see FIGS. 3 and 5), the dried strawberry product in the present invention substantially maintains the morphology and color of the fresh strawberry (see FIG. 2), the morphology of the dried strawberry product is significantly better than the dried strawberry slice obtained by other traditional method (see FIGS. 7, 9, 11, 13 and 15).

The flavor of the dried strawberry product is not reduced due to desiccation. By external sensory testing, the fragrance which is the same as that of the fresh strawberry can obviously be smelled.

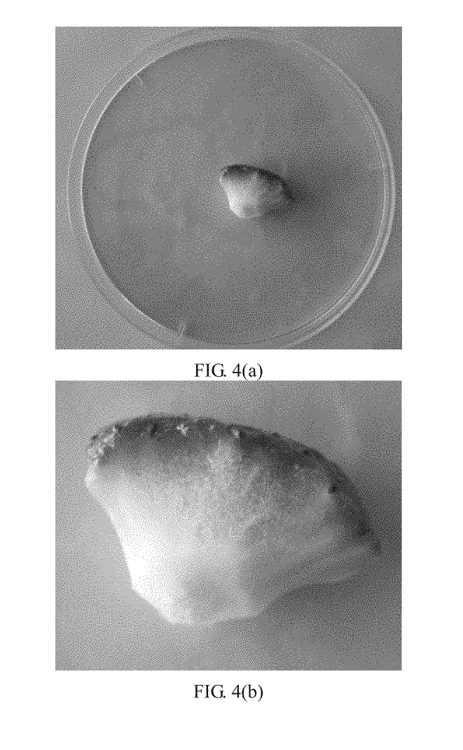

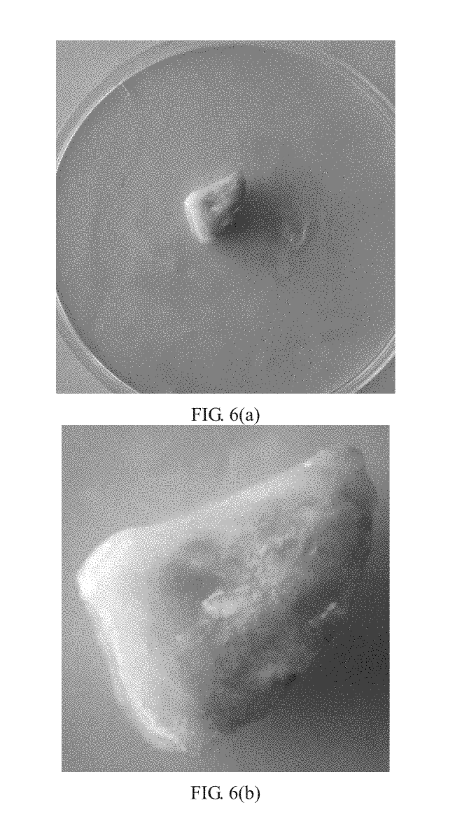

Unlike the dried strawberry product obtained by stoving or baking, the dried strawberry product provided in the present invention still has the ability of absorbing water, that is to say, when the dried strawberry product is dipped in water or sprayed with water, the dried strawberry product can absorb the moisture. Meanwhile, the dried strawberry product can recover by absorbing water (water absorption recovery), which refers to that the dried strawberry product, after absorbing the moisture, can be substantially restored to the morphology and color of the fresh strawberry (see FIGS. 4 and 6). The rate of water absorption of the dried strawberry product obtained by the embodiment of the present invention measured by using the method for measuring the rate of water absorption as described hereinafter is the same as that obtained by using the conventional method of FD method, and is significantly better than the product obtained by the method of stoving and baking.

In one embodiment according to the present invention, with reference to the strawberry sample obtained by the following Embodiments 1 and 2 (see: FIG. 3 to FIG. 6), the strawberry after water absorption is substantially restored to the morphology and color of the fresh strawberry. In a specific embodiment, a rate of water absorption measured by the water absorption experiment as described below is 3.58.

In one embodiment according to the present invention, the water content of the dried strawberry product is measured by using the method for measuring the water content as described below, and the dried strawberry product contains water in a content of lower than 5 wt %, preferably lower than 4 wt %, and more preferably lower than 3 wt %. The above range of water content is in line with the current requirement on the water content of the dried vegetables and fruits. The nutritional ingredients of the dried strawberry product provided in the present invention have been effectively preserved, with respect to the strawberry sample obtained by the following embodiment and comparative example, the SOD enzyme activity exhibited by respective dried strawberry products and the anthocyanin contained in respective dried strawberry products are measured by the method of measurement of SOD enzyme activity and anthocyanin content according to the following text. The results show that both the SOD enzyme activity and the content of anthocyanin in the dried strawberry product in the present invention are better than those of the comparative examples. Results obtained by the method of measurement according to the following text show that the dried strawberry product exhibits an SOD enzyme activity U2 of 650 U/g of strawberry (calculated on a dry weight basis), preferably 800 U/g of strawberry (calculated on a dry weight basis), more preferably 900 U/g of strawberry (calculated on a dry weight basis), more preferably 1000 U/g of strawberry (calculated on a dry weight basis), most preferably 1200 U/g of strawberry (calculated on a dry weight basis).

In one embodiment according to the present invention, with respect to the obtained dried strawberry product, the SOD enzyme activity exhibited by the dried strawberry products is measured by the method for the measurement of the SOD enzyme activity according to the following text. Whereas, with respect to the fresh strawberry with the same volume as the obtained dried strawberry product, the content of SOD enzyme exhibited in the strawberry feedstock prior to cooling and sublimating, which has been treated to be the dried strawberry product to be obtained is measured by using the method for the measurement of the SOD enzyme activity according to the following text as well. The SOD enzyme activity of the fresh strawberry block is converted to that on a dry weight basis by the method according to the following text.

The dried strawberry product is provided according to another aspect of the present invention, wherein the SOD enzyme activity of the dried strawberry product is increased greater than 80%, preferably greater than 100%, comparing the

SOD enzyme activity exhibited by the dried strawberry product U2 (calculated on a dry weight basis) to the SOD enzyme activity exhibited by the feedstock for preparing the same (calculated on a dry weight basis). When measured by the same method, the dried strawberry product obtained by the present invention exhibits an SOD enzyme activity higher than the SOD enzyme activity exhibited by the fresh dried strawberry product. The results indicate that after the fresh strawberry is treated according to the present invention, the SOD enzyme activity exhibited thereby is easier to be detected, and the results also indicate that after the dried strawberry product of the present invention is eaten, the substances exhibiting the SOD enzyme activity is in a state easier to be absorbed and utilized. The results further indicate that the substances exhibiting the SOD enzyme activity in the dried strawberry product of the present invention is substantially intact, and maintains as original to a large extent.

The dried strawberry product provided by the present invention exhibits a high SOD enzyme activity, and the activity data thereof is significantly higher than the SOD enzyme activity exhibited by the dried strawberry product obtained by other method of the prior art.

The hardness of the dried strawberry product provided by the present invention measured by the Shore Hardness Tester is lower than the hardness of the dried strawberry product obtained by the traditional method. The results obtained by the method for measurement according to the following text show that the hardness is substantially below 18, and may be in a range of 12-18 The dried strawberry product provided by the present invention is more brittle with a better taste.

In one embodiment according to the present invention, the content of anthocyanin in the dried strawberry product is measured by using the method for the measurement of anthocyanin content according to the following text. With respect to obtaining the fresh strawberry block with the same volume as the dried strawberry product, the content of anthocyanin in the strawberry feedstock prior to the steps of cooling and sublimating, which has been treated to be the dried strawberry product to be obtained, is measured by using the method for the measurement of anthocyanin content according to the following text as well. The dried strawberry product is provided according to another aspect of the present invention, wherein calculated on a dry weight basis, the content of anthocyanin in the dried strawberry product is above 200 mg/100 g of strawberry, preferably above 240 mg/100 g of strawberry. The content of anthocyanin in the dried strawberry product provided by the present invention is significantly higher than that in other dried strawberry product obtained by the method of the prior art.

The dried strawberry product is provided according to another aspect of the present invention, wherein the dried strawberry product has an outer surface chroma higher than the fresh strawberry feedstock for preparing the same. In a specific embodiment, the outer surface has a value of 7626-7627 measured by color atla (PANTONE color atla).

<Method for Manufacturing Dried Strawberry Product>

In a specific embodiment according to the present invention, there provided a method for manufacturing dried strawberry product with a high SOD enzyme activity. The method comprises the first step of providing fresh strawberry, and cooling the fresh strawberry at a cooling rate of lowering 20° C. or more, preferably 30° C. or more, more preferably 40° C. or more, more preferably 60° C. or more, and more preferably 90° C. or more, per minute, and a further step of sublimating the fresh strawberry that has undergone the step of cooling.

According to the above described steps, the step of providing fresh strawberry refers to conducting a simple pre-treatment for the strawberry obtained freshly, or the fresh strawberry feedstock, such as washing, slicing or pelletizing, etc., so as to obtain fresh strawberry block or strawberry particle with certain shape and size.

In the present invention, it is not necessary to conduct other pre-treatment step for the strawberry piece, strawberry block, strawberry dice and strawberry particle obtained by slicing or pelletizing, such as conducting the step of the conventional color-protection with chemical agent, so that the nutritional ingredients, especially the ingredients exhibiting the SOD enzyme activity and anthocyanin can be prevented from losing into the treatment solution of chemical agents used thereby

The dried strawberry product prepared by using the method according to the present invention, even in a case that it is not treated by the chemical agents, can still substantially completely maintain the original color and flavor of the fresh strawberry, and meanwhile can prevent the loss of the nutritional ingredients, especially the water-soluble ingredients.

The above chemical agent treatment includes, for example, pre-treatment by using the chemical agent (e.g., the pre-treatment step carried out in order to protect the color).

According to a specific embodiment of the present invention, it is preferable to treat the fresh strawberry by rapid freezing, so that the fresh strawberry is cooled at a cooling rate of 20° C. or more, preferably 30° C. or more, more preferably 40° C. or more, more preferably 60° C. or more, and more preferably 90° C. or more, per minute.

In one specific embodiment of the present invention, in order to achieve such a cooling rate, it is preferable to cool the fresh strawberry by using liquid nitrogen, such as immersing fresh strawberry slices into liquid nitrogen or spraying liquid nitrogen on the surface of fresh strawberry. And other medium can also be used for controlling the cooling of the fresh strawberry.

In one specific embodiment of the present invention, the rapid freezing is achieved by using liquid nitrogen. According to the need, the fresh strawberry can be immersed into liquid nitrogen. There is no specific limitation to the liquid nitrogen used in the present invention. The liquid nitrogen is commercially available. The liquid nitrogen can be used as long as it does not contain harmful substances and it conforms to the relevant specifications. In addition, other modes can be used for achieving rapid freezing.

In one specific embodiment of the present invention, the fresh strawberry at an ambient temperature (usually about 20-25° C.) is immersed into liquid nitrogen, with different size and volume of the fresh strawberry, the time for immersing is different to a certain extent, which is basically controlled to be immersed in the liquid nitrogen for about 1˜30 minutes, preferably 1˜5 minutes.

After cooling at the above-mentioned cooling rate, the cooling process usually ends when the temperature is not further reduced, and the fresh strawberry feedstock having undergone the cooling process is transferred to the apparatus for drying (sublimating). The temperature of the fresh strawberry feedstock in the cooling process can also be measured by a temperature measuring device, so as to control the time for cooling.

In one specific embodiment of the present invention, the probe of the temperature sensor is inserted into the fresh strawberry block, which is immersed into the liquid nitrogen, as displayed by the pointer of the temperature sensor, for about 1 minute, the temperature decreases from room temperature to −96° C., and after 30 minutes, the temperature displayed by the temperature sensor is constantly kept at −96° C. It can be determined according to the embodiment that, the fresh strawberry is cooled at a cooling rate of 20° C. or more, preferably 30° C. or more, more preferably 40° C. or more, more preferably 60° C. or more, and more preferably 90° C. or more, per minute.

In one specific embodiment of the present invention, the strawberry feedstock in the cooling process by using liquid nitrogen can be deemed as having been cooled completely by immersing in the liquid nitrogen for 5 minutes, with respect to the strawberry block with a radial dimension of 5 cm.

After the cooling process, drying (sublimating) treatment can be conducted directly (without any treatment) for the cooled strawberry. Preferably, the sublimating treatment for the cooled strawberry can be conducted under a vacuum condition.

The above-mentioned sublimating step is preferably carried out under a vacuum condition. For example, the sublimating step for the cooled fresh strawberry can be performed under a condition of a vacuum degree above 133 Pa, preferably under a condition of a vacuum degree below 300 Pa. In the past, the sublimating step is typically performed under a condition of a vacuum degree from 30 to 100 Pa. However, the sublimating step in present invention can be performed under a condition of a vacuum degree above 133 Pa, and it is not necessary to control the vacuum degree of the sublimating step strictly at a very low level. Since a relatively long time is required for performing the sublimating step, for example, over 48 hours, or about 60˜72 hours, the condition above 133 Pa and below 300 Pa, as compared with that in the past vacuum sublimating step, can greatly reduce energy consumed in the process of vacuum sublimating. Although it is not limited to theory, it can be inferred that operation in a wider range of vacuum degree is mainly due to a very high rate at which the strawberry feedstock is cooled in the cooling process. Rapid cooling enables the moisture to be fixed in situ, limits free movement of water molecules, and reduces the possibility of oriented aggregation of the water molecules into ice crystals. In general, the ice crystal growth is a process that water molecules are constantly stripped from the cytosol, and then water molecules undergo an oriented aggregation to form small ice crystals which grow into large ice crystals. Such mode reduces the formation of large ice crystals, so that when the water molecules are sublimated to overflow, they do not need to overcome restraint from other crystals, and are more likely to overflow.

Sublimating can be performed at a temperature of 90° C. or less, preferably within a temperature range of 40˜90° C. It should be understood that according to different shapes of fresh strawberry, different sublimating temperature and time may be adopted.

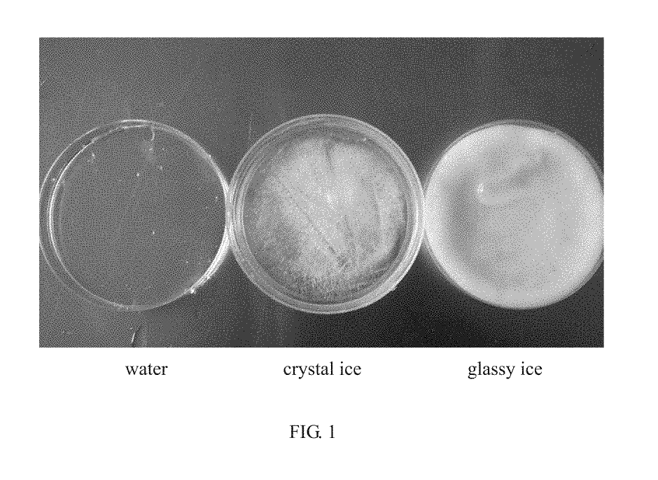

As is not limited to theory, in the present invention, the fresh strawberry is manufactured into a dried strawberry product, and in the above process, since the fresh strawberry is cooled at a cooling rate of 20° C. or more, preferably 30° C. or more, more preferably 40° C. or more, more preferably 60° C. or more, more preferably 90° C. or more, per minute, the moisture in the fresh strawberry will form glassy ice within a very short period of time (for example, 1 minute). The “glassy ice” refers to ice in a glassy state (referred to as glassy ice for briefness) which is formed by the moisture in the fresh strawberry, including the a majority of moisture in the cell tissue or cells, in a mode of rapid cooling or other mode, which does not form the ice in a crystalline state (i.e., the ice crystal in a common sense, also referred to as “crystal ice”). The glassy ice is different from crystal ice, wherein glassy ice is a kind of ice in an amorphous state, which does not form crystal during the ice-formation process, and does not have uniform and periodic crystal structure. The appearance of glassy ice and crystal ice are shown in FIG. 1, wherein in appearance, the crystal ice is transparent, whereas the glassy ice is opaque, and presents a color of milk white,

As is not limited to theory, the method involved in the present invention is to enable the moisture in the fresh strawberry to form the glassy ice (which is typically achieved in a mode of rapid freezing the fresh strawberry), that is, the whole process is water molecules—glassy ice (amorphous)—vacuum sublimating drying of water molecules. Since there is substantially no process of formation of crystal ice/no existence of growth process of crystal ice, the cells of the fresh fruits and vegetables will not be damaged, the dried strawberry product obtained thereby has a substantially complete internal cellular structure and exhibits a sponge appearance. In addition, after re-absorption, moisture can return, so that the dried strawberry product will substantially restore to original morphology.

In the method of the present invention, the fresh strawberry is cooled at a very high rate, and forms the above-mentioned state of glassy ice at a very high rate, which may further reduce damage to the ingredients in the strawberry feedstock. In addition, the strawberry in a glassy ice state is substantially stable in internal structure, that is, the strawberry in a glassy ice state directly enters into the subsequent sublimating step.

As is not limited to theory, after sublimating the glassy ice formed in the fresh strawberry, the dried strawberry product as claimed in the present invention is obtained. During the process of sublimating, since glassy ice is formed in the frozen fresh strawberry obtained by the present method, the phase of crystal ice is not necessary during the process of sublimating the glassy ice, the sublimating step is simplified, accelerated and/or improved.

In the present invention, the dried strawberry product obtained in the present invention is also compared with the traditional sample obtained by the comparative example, by using the following test methods.

I. Sensory Analysis Test

The following sensory analysis tests in three aspects of vision, olfaction and gustation are performed for the dried strawberry product of the present invention and the dried strawberry product in the comparative example involved in the following text.

Sixteen sensory analysts with a general olfaction and gustation sensitivity and without color blindness or color weakness are selected for performing the sensory analysis tests for strawberry, including fresh strawberry product and dried strawberry product. The sensory analysis tests are respectively specific to three aspects of vision, olfaction and gustation.

The following samples obtained according to embodiments and comparative examples as well as fresh strawberry are put on A4 pure white printing paper, and each piece of A4 paper is placed with the same type of sample, for example, with strawberry sample. The A4 paper placed with the sample is provided to the sensory evaluation personnel. The sensory evaluation personnel evaluate the sample in three aspects of vision, olfaction and gustation.

(1) Evaluation of Maintenance Degree of the Color/Morphology

The sensory analysis in vision is evaluated by maintenance degree of the color/morphology. The maintenance degree of the color/morphology takes the color/morphology of the fresh strawberry as a score of 10, then the sensory evaluation personnel observe respectively and independently, evaluate difference in color/morphology between the dried strawberry product obtained thereby and the fresh strawberry, and then provide the corresponding scores according to the following grading criteria:
10: having the color/morphology of fresh strawberry;
9: being substantially the same as the color/morphology of fresh strawberry;
7-8: approximately keeping the color/morphology of fresh strawberry, without blackening or significant deformation;
5-6: approximately keeping the color/morphology of fresh strawberry, with slightly discoloration and deformation;
4: being recognizable in color/morphology of strawberry, with a certain degree of discoloration and deformation;
3: being recognizable in color/morphology of strawberry after carefully identification, with discoloration (mainly darkening to black) and more obvious distortion;

0-2: being substantially unrecognizable in color/morphology of strawberry, with discoloration (mainly darkening to black) and very obvious deformation.

(2) Evaluation of Smell Maintenance Degree

The sensory analysis in olfaction is evaluated by smell maintenance degree. The smell maintenance degree takes the original fragrance of fresh strawberry as a score of 10, then the sensory evaluation personnel smell respectively and independently, evaluate difference in smell between the dried strawberry product obtained thereby and the fresh strawberry, and then provide the corresponding scores according to the following grading criteria:
10: having the fragrance of fresh strawberry;
9: being substantially the same as the fragrance of fresh strawberry;
7-8: approximately keeping the fragrance of fresh strawberry, without other abnormal odor;
5-6: approximately keeping the fragrance of fresh strawberry, substantially without other abnormal odor;
4: merely having a very light aroma of fresh strawberry, with a little abnormal odor;
3: being recognizable in aroma of fresh strawberry after carefully identification, with obvious abnormal odor;
0-2: having no aroma of fresh strawberry_{;} with strong abnormal odor;

(3) Evaluation of Taste Preference

The sensory analysis in gustation is evaluated by taste preference. The taste preference takes the taste feel of fresh strawberry as a score of 10, then the sensory evaluation personnel respectively and independently taste, evaluate difference in taste feel between the dried strawberry product obtained thereby and the fresh strawberry, and then provide the corresponding scores according to the following grading criteria:
10: having the flavor of fresh strawberry;
9: being substantially approximate to the flavor of fresh strawberry;
7-8: approximately keeping the flavor of fresh strawberry, without any abnormal odor;
5-6: keeping a little flavor of fresh strawberry, substantially without abnormal odor;
4: merely having a very light flavor of fresh strawberry, with a little abnormal odor;
3: being able to feel a little flavor of fresh strawberry after carefully identification, with a certain abnormal odor;
1-2: having no flavor of fresh strawberry, with strong abnormal odor;
0: being unpleasant for the sensory evaluation personnel to have a taste due to a very poor visual and olfactory feature of the product.

According to the above method of evaluation, the dried strawberry product provided by the present invention has a maintenance degree of the color/morphology scored above 7.0, or further preferably a maintenance degree of the color/morphology that is at least 1.0 higher than the commercial dried strawberry product, wherein the maintenance degree of the color/morphology of said dried strawberry product is obtained by the sensory analysis test, with the color/morphology of the fresh strawberry as a score of 10.

The dried strawberry product provided by the present invention has a smell maintenance degree scored above 7.0, or further preferably a smell maintenance degree that is at least 2.0 higher than the commercial dried strawberry product, wherein the smell maintenance degree of said dried strawberry product is obtained by the sensory analysis test, with the smell of the fresh strawberry as a score of 10.

The dried strawberry product provided by the present invention has a taste preference scored above 8.0, or further preferably a taste preference that is at least 0.4 higher than the commercial dried strawberry product, wherein the taste preference of said dried strawberry product is obtained by the sensory analysis test, with the taste preference of the fresh strawberry as a score of 10.

II. Measurement of Water Absorption

A piece of strawberry block is weighed and placed into a plate, when a weight m₁ is recorded, then distilled water is drawn and slowly dripped on the strawberry block, maintaining for 2 minutes, till the strawberry no longer absorbs water, and meanwhile the weight does not change any more, excessive water in the plate is wiped off, when m₂ is recorded. The rate of water absorption=m₂/m₁.

The photos of the samples in the embodiment of the present invention and the comparative example before and after absorption are respectively shown from FIG. 3 to FIG. 6.

The rate of water absorption can be derived by using the following formula:

F=m₂/m₁.

III. Measurement of Water Content

The dried strawberry product obtained from the embodiment and the comparative example is mashed in the sample sacks, then 1 g of the mashed dried strawberry product is weighed and taken in parallel, and the water contents of the fresh strawberry feedstock and the dried strawberry product are measured according to the description by using the HB43-S Halogen Moisture Analyzer produced by Mettler-Toledo Instruments (Shanghai) Co., Ltd. The fresh strawberry sample is sliced into a slice with a thickness of 2 mm, and 1 g thereof is weighed to measure the water content of the fresh strawberry sample, wherein the preset maximum temperature is 105″C.

IV. Measurement of SOD Enzyme Activity

The contents of SOD enzyme shown in the fresh strawberry block and the dried strawberry product are measured by the method for measuring the SOD enzyme activity according to the means of pyrogallol auto-oxidation.

The means of pyrogallol auto-oxidation has the following steps:

(1) Experiment Reagents

| | |
|---|---|
| Sodium hydroxide | AR Tianjin Chemical Reagent |
| | Wholesale Co., Ltd |
| Hydrochloric acid | AR Beijing Yili Fine Chemicals Co., Ltd |
| EDTA 2Na | Sinopharm Chemical Reagent Co., Ltd |
| Anhydrous sodium carbonate | AR Tianjin Chemical Reagent |
| | Wholesale Co., Ltd |
| Sodium bicarbonate | AR Beijing Beihua Fine Chemicals LLC. |
| Disodium hydrogen phosphate | AR Tianjin Chemical Reagent |
| | Wholesale Co., Ltd |
| Sodium dihydrogen phosphate | AR Tianjin Chemical Reagent |
| | Wholesale Co., Ltd |
| Pyrogallol | AR Tianjin Guangfu Fine Chemicals |
| | Research Institute |
| Luminol (≧97%, HPLC) | Sigma |

(2) Experiment Instruments

BPCL-2-ZL-SH15-TGC Ultra-Weak Chemiluminescence Meter (Institute of Biophysics, Chinese Academy of Sciences).

3.1 Method of Experiment

3.1 Preparation of Sample Solution

About 0.5 g of dried powder or about 5.0 g of fresh sample is weighed, PB buffer solution of 10 mL is added, mixed sufficiently and shaken for 2 hours, then filtered for test. Each sample requires 3 parallels.

3.2 Measurement of SOD Enzyme Activity

In the present invention, pyrogallol-luminol chemiluminescence system is used. The luminol is prepared into a solution with a concentration of 1 mmol/L by using 0.05 mol/L NaOH solution, and is stored in a dark place, which is diluted to a solution with a concentration of 0.1 mmol/L by using 0.05 mol/L NaOH solution. The pyrogallol is prepared into a solution with a concentration of 10 mol /L by using 10 mol/L HCl solution, and is stored in refrigerator at a temperature of 4° C., which is diluted 16 times (6.25×10−4 mol/L) with distilled water before use. The 0.05 mol/L, sodium carbonate-sodium bicarbonate buffer (containing 0.1 mmol/L EDTA) with pH=10.2 is mixed with 0.1 mmol/L luminol before the experiment with a ratio of 2:1 (V:V) into a mixture of luminol and carbonate buffer, During measurement, 10.0 μL, of the ample is injected into the luminescence pool (with the sample buffer as a control), then 50 μL of 6.25×10−4 mol/L pyrogallol is injected, finally, 940 μL of the mixture of luminol and carbonate butler is added to initiate the reaction (25° C.), the luminous intensity is recorded with an interval of 1 second, the total integrated luminous intensity during 180 seconds is measured. The background luminous intensity is the luminous intensity when pyrogallol is not added.

3.3 Step of Measurement

\textcircled{1} Control background: 10.0 μL of PB buffer+940 μL of the mixture of luminol and carbonate butler.

\textcircled{2} Control: three times in parallel, 10.0 μL of PB buffer+50 μL of 6.25×10−4 mol/L, pyrogallol+940 μL of the mixture of luminol and carbonate buffer are injected into the luminescence pool.

\textcircled{3} Sample background: 10.0 μL of sample extract+940 μL of the mixture of luminol and carbonate buffer.

\textcircled{4} Sample: 10.0 μL of sample extract+50 μL of 6.25×10−4mol/L pyrogallol+940 μL of the mixture of luminol and carbonate buffer are injected into the luminescence pool, each sample having three parallels.

4 Data. Processing

4.1 Calculation of Inhibition Rate

According to the total integrated luminous intensity of the control and the sample measured thereby, the inhibition rate is calculated in accordance with the following equation:

$$Scavenging activity ( inhibition rate ) = \frac{( CLcontrol - CLo ) - ( CLsample - CLo )}{CLcontrol - CLo}$$

Where: CLcontrol—the total integrated luminous intensity of the blank control group: CLo—the total integrated luminous intensity of the background group; CLsample—the total integrated luminous intensity of the sample group.

4.2 Establishment of Regression Equation

With the total integrated luminous intensity of the blank control group as 100%, the percentage of luminescence inhibition after addition of different concentrations of SOD standard products, whereby a linear regression equation is established for the logarithmic value of the SOD concentration, so as to derive the SOD concentration when 50% luminous intensity is inhibited (C50, unit: μg/ml), which is determined as an activity unit, and the regression equation is as follows:

Y52.181 log SOD−74.406, R2=0.9917

C50=242.17 μg/ml

In the regression equation, Y represents the inhibition rate, SOD represents the SOD concentration.

4.3 Calculation of C-Sample

C-sample is derived according to the inhibition rate of the sample and the regression equation:

log C sample=(Y+74.406)/52.181

C sample=10̂ log SOD

4.4 Calculation of SOD Enzyme Activity of the Sample

The unit SOD enzyme activity in the sample is calculated by the following equation:

Sample SOD enzyme activity (U/g)=(C sample/C50)×(total volume of sample ml/sample mass g)

For comparison, the SOD enzyme activity shown in the present invention is the SOD enzyme activity uniformly calculated on a dry weight basis, the specific method for calculating the SOD enzyme activity on a dry weight basis is as follows:

$$Y = \frac{A}{1 - D}$$

Y: a numerical value calculated on a dry weight basis; A: a detected value of SOD enzyme activity by using the above method; D: a water content of the sample measured by using the above-described method.

V. Measurement of Anthocyanin Content

1. Experiment Reagents

Anhydrous alcohol (AR), hydrochloric acid (AR).

Extract: methanol solution containing 0.1% of hydrochloric acid.

2. Experimental Instrument

UV2800 UV spectrophotometer, refrigeration centrifuge, electronic analytical balance, vortex instrument, and so on.

3. Method of Experiment

3.1 Preparation of Sample Solution of Anthocyanin

The sample is mashed into powder in a sample sack, 1.00 g of the powder is weighed and placed in a 50 ml centrifuge tube, 9 ml of distilled water is added (equivalent to a ratio of water absorption being 10), and mixed even. Then 0.50 g of the water absorption sample is weighed, 10 ml of extract is added, mixed even by vortex, and oscillated in dark for 30 minutes, filtered, and the filtrate is taken for measurement, with 3 parts in parallel.

3.2 Measurement of Anthocyanin Content

The test solution is diluted to an appropriate concentration, with the extract as a blank control, the absorbance A value is measured on the UV2800 UV-visible spectrophotometer at 529 nm, so that the absorbance value is in a range of 0.2 to 0.8.

3.3 Data Processing

The anthocyanin concentration in the sample solution is calculated according to the regression equation C (μg/ml):

C=16.083 A+0.3422(r=0.9989)

In the regression equation. C is the measured anthocyanin concentration in the sample solution, μg/m1; A is the absorbance value; the linear range is 2.9˜14.5 μg/ml.

The anthocyanin content is calculated according to the equation:

Anthocyanin content(mg/100 g)=(C×D×V)/(m×10)

In the equation, C is the measured anthocyanin concentration in the sample solution, μg/ml; D is a dilution multiple; V is a volume of the extract, ml; m is a mass of the sample, g.

Note: it is necessary to consider a ratio of water recovery for the strawberry dried sample, which is calculated by the following equation:

Anthocyanin content(mg/100 g)=(C×D×V×F)/(m×10)

In the equation, C is the measured anthocyanin concentration in the sample solution, μg/ml; D is a dilution multiple; V is a volume of the extract, ml; m is a mass of the sample, g; F is the ratio of water recovery.

For comparison, the anthocyanin content shown in the present invention is the anthocyanin content uniformly calculated on a dry weight basis, the specific method for calculating the anthocyanin content on a dry weight basis is as follows:

$$Y = \frac{A}{1 - D}$$

Y: a numerical value calculated on a dry weight basis; A: a detected value of anthocyanin content by using the above method; D: a water content of the sample measured by using the above-described method.

VI. Measurement of Chroma of Strawberry

Method for measurement of chroma: the fresh strawberry as well as the dried strawberry product prepared by the method of the present invention and the dried strawberry product prepared by the traditional method are compared in color with PANTONE color atla (PANTONE color atla Company in the United States of America), to obtain numerical values of chroma of respective samples.

VII. Measurement of Hardness of Strawberry

Hardness is measured by using the Shore Hardness Tester: Type LX-C; bracket model, LAC-J, Manufacturer: Haibao Instrument Co., Ltd. in Yueqing City, Zhejiang Province. The specific method for measurement of hardness is as follows: placing the dried strawberry product prepared by the method of the present invention and the dried strawberry product prepared by the traditional method on a circular platform on the bracket, loosening the star-shaped handle on the cross-arm, adjusting the height of the cross-arm, to a position where the bottom of the presser foot (needle) of the durometer is about 5 mm from the surface of the test sample, tightening the star-shaped handle on the cross-arm, pressing down the handle, so as to read the durometer within 1 second when the presser foot (needle) is completely in contact with the test sample under the action of gravity of a fixed-load weight, the numerical value displayed by the durometer being the hardness value of the test sample. In order to improve the accuracy of the test, test at least 5 times at different positions 6 mm from the measuring points, and obtain the average value.

In the process from the fresh food to the dried product, due to short time of treatment, the dried strawberry product obtained in the present invention maintains the maximum degree of the original shape, color, smell, and taste; meanwhile, in the process of preparation and preservation, there is no need to add any processing aids or additives, or to perform any additional processing steps, which also helps to maintains the original shape, color, smell, and taste of fresh strawberries.

In addition, the dried strawberry product obtained in the present invention maintains the maximum degree of SOD enzyme and anthocyanin, and the content per gram in the dried strawberry product increases substantially as compared with that in the fresh strawberry, which indicates that the method for manufacturing the dried strawberry product according to the present invention basically do not damage the nutritional ingredients existing in the fresh strawberry.

In order to further clearly illustrate the technical solution provided in the present invention, the following embodiments and comparative examples are provided. However, the following embodiments and comparative examples are only provided for the purposes of illustration, but cannot be understood that the present invention is only limited to the following technical solutions. In the present invention, the numerical values involved generally refer to weights or weight percentages unless otherwise specified.

### EMBODIMENTS

### Embodiment 1 Preparation of Dried Strawberry Product 1

Newly purchased Akihime strawberry is selected as the feedstock of the dried product. The fresh strawberry is washed clean and drained off water, and then cut into slices, each strawberry block having a thickness of about 0.8 cm, and a length of 3˜5 cm, photos of the strawberry block obtained thereby being shown in FIG. 1. Then the strawberry blocks are immediately placed in a plastic jar, taking about two-thirds of the full jar. The plastic jar is carefully placed into a pail of a liquid nitrogen container, so that the pail is slowly immersed into the liquid nitrogen, when it is completely soaked with liquid nitrogen. After standing for 5 minutes, the strawberry block is placed into a freeze dryer (LGJ-10 freeze dryer, produced by Beijing Songyuan Huaxing Technology Development Co., Ltd.), and dried for more than 60 hours. After completion of drying, the dried strawberry product as shown in FIG. 3 is obtained.

### Embodiment 2 Preparation of Dried Strawberry Product 2

Newly purchased Akihime strawberry is selected as the feedstock of the dried product. The fresh strawberry is washed clean and drained off water, and then cut into slices, each strawberry block having a thickness of about 0.8 cm, and a length of 3˜5 cm, then the strawberry blocks are placed on a screen mesh and liquid nitrogen is sprayed thereon for 5 minutes. After the end of spraying, the strawberry blocks are placed into a freeze dryer (LGJ-10 freeze dryer, produced by Beijing Songyuan Huaxing Technology Development Co., Ltd.), and dried for more than 60 hours. After completion of drying, the dried strawberry product as shown in FIG. 5 is obtained.

### Embodiment 3 Optimization of Time for Liquid Nitrogen Immersion

In addition to change of the time for liquid nitrogen immersion, the dried strawberry product is prepared likewise according to the method of Embodiment 1. In the present embodiment, the purchased Akihime strawberry is used. And the time periods for immersion in the liquid nitrogen are respectively 5 minutes, 10 minutes, and 30 minutes. The content of SOD enzyme in the dried strawberry product obtained thereby is measured, wherein the SOD enzyme activity of the dried strawberry product obtained by immersion for 5 minutes is 975.581 U/g, the SOD enzyme activity of the dried strawberry product obtained by immersion for 10 minutes is 1237.961 U/g, the dried strawberry product obtained by immersion for 30 minutes is 1185.485 U/g. According to the results of Example 3, more excellent dried strawberry product can be obtained by immersion from 5 minutes to 30 minutes.

### Embodiment 4 Preparation of Different Kinds of Dried Strawberry Product

In addition to use of the purchased Beauty strawberry and Akihime strawberry, dried strawberry products are obtained respectively according to the method the same as that in Embodiment 1 and Embodiment 2.

### COMPARATIVE EXAMPLE 1

### Commercially Available Freeze-Dried Strawberry Sample

The freeze-dried strawberry sample of Lezi (registered trademark) is purchased commercially, as shown in FIG. 7.

### COMPARATIVE EXAMPLE 2

### Strawberry Sample Obtained by Direct Drying

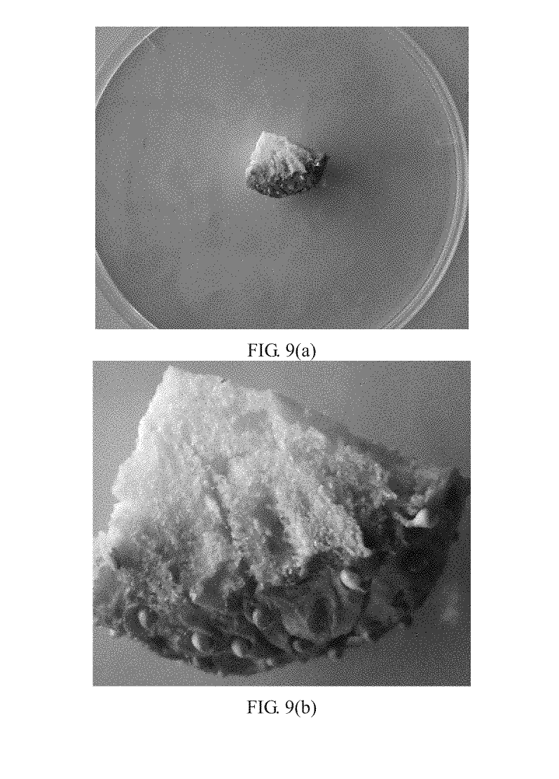

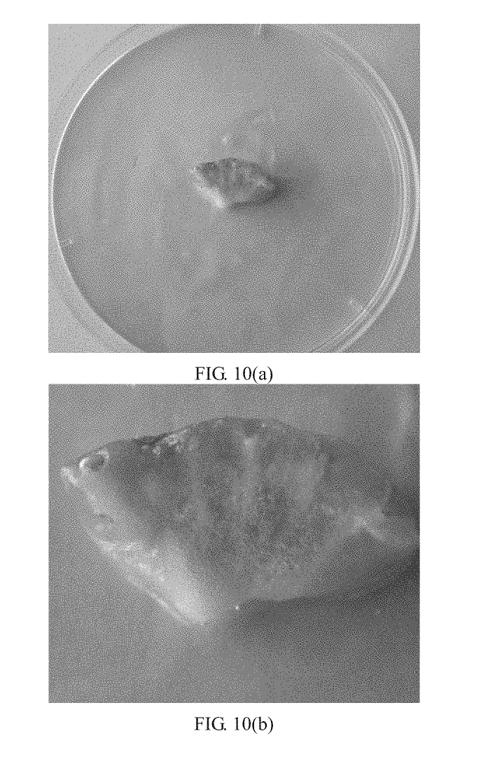

Newly purchased Akihime strawberry is selected as the feedstock of the dried product. The fresh strawberry is washed clean and drained off water, and then cut into slices, each strawberry block having a thickness of about 0.8 cm, and a length of 3˜5 cm. The strawberry block obtained thereby is placed into a freeze dryer (LGJ-10 freeze dryer, produced by Beijing Songyuan Huaxing Technology Development Co., Ltd.), and dried for more than CO hours. After completion of drying, the strawberry sample is taken out and the strawberry sample as shown in FIG. 9 is obtained.

### COMPARATIVE EXAMPLE 3

### Strawberry Sample Obtained by Traditional Drying

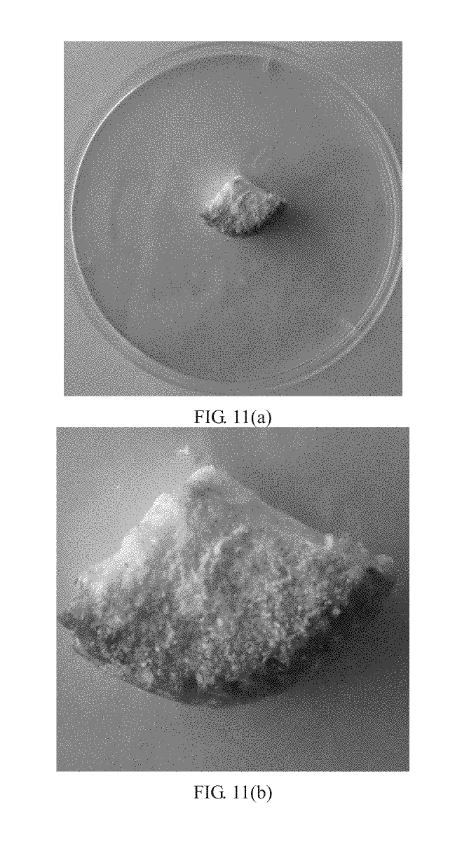

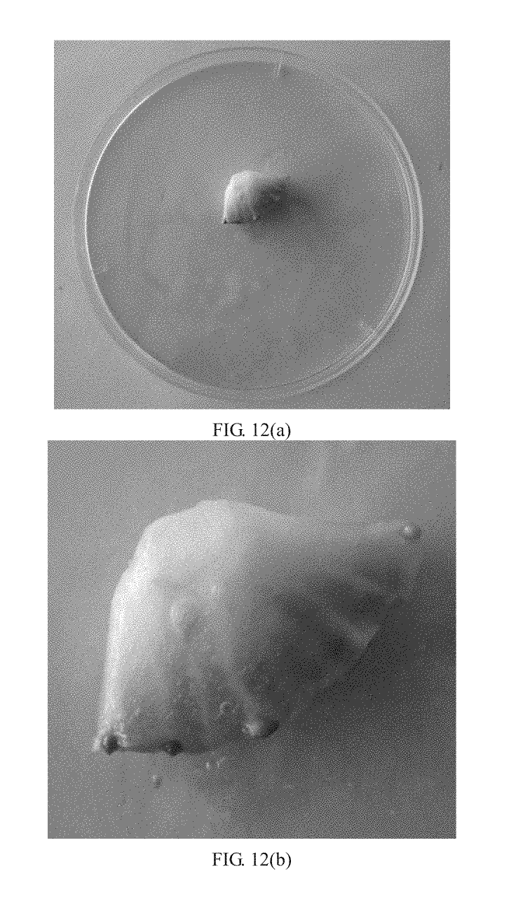

Newly purchased Akihime strawberry is selected as the feedstock of the dried product. The fresh strawberry is washed clean and drained off water, and then cut into slices, each strawberry block having a thickness of about 0.8 cm, and a length of 3˜5 cm. Then the strawberry blocks are immediately placed in a plastic jar, taking about two-thirds of the full jar. The plastic jar is carefully placed into the freezing layer of the refrigerator (−20° C.) and kept for more than 48 hours, then the sample is taken out from the freezing layer of the refrigerator and put into a freeze dryer (LGJ-10 freeze dryer, produced by Beijing Songyuan Huaxing Technology Development Co., Ltd.), and dried for more than 60 hours. After completion of drying, the strawberry sample is taken out and the strawberry sample as shown in FIG. 11 is obtained.

### COMPARATIVE EXAMPLE 4

### Strawberry Sample Dried by Stoving

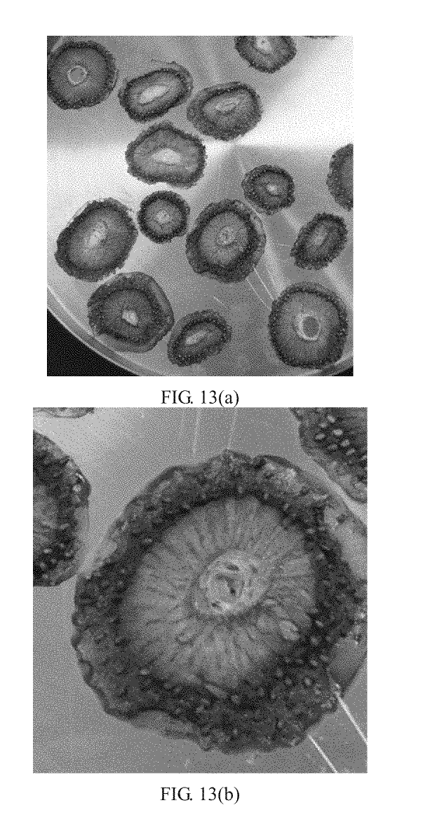

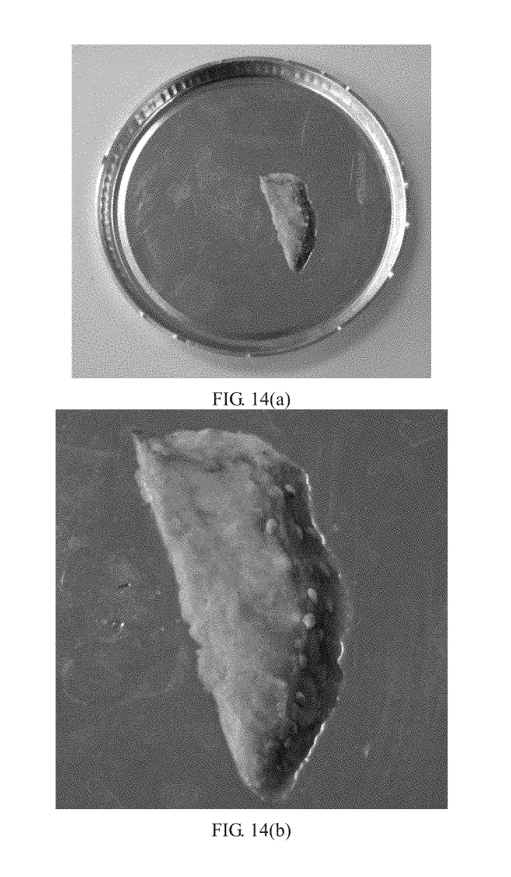

According to the same method in Embodiment 1, the newly purchased Akihime strawberry is cut into slices, and the strawberry blocks obtained thereby are placed into a hot blow dryer (DHG electrothermal blowing drying box, produced by Shanghai Hengyi Technology Co., Ltd), being dried by hot blow for 24 hours at a temperature of 75° C., then the strawberry sample dried by staving is obtained as shown in FIG. 13.

### COMPARATIVE EXAMPLE 5

### Strawberry Sample Dried by Baking

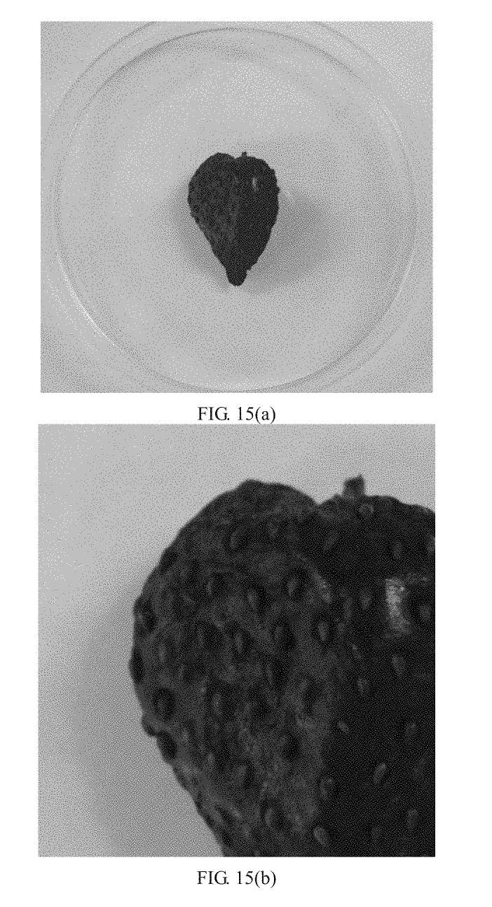

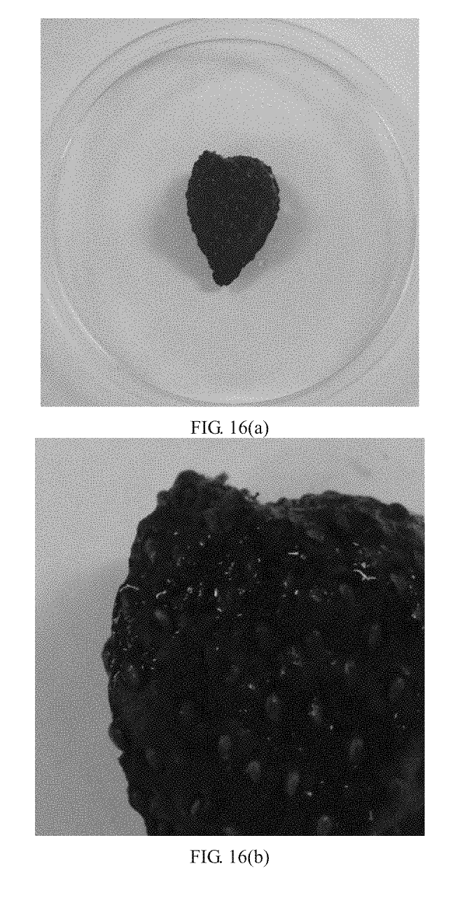

According to the same method in Embodiment 1, the newly purchased Akihime strawberry is cut into slices, and the strawberry blocks obtained thereby are placed into a household oven (SO-18A multi-function electric oven, produced by Xianchuang Household Appliance Sales Co., Ltd.), being baked for 2 hours at a temperature of 150° C., then the strawberry sample dried by baking is obtained as shown in FIG. 15.

The dried strawberry products obtained by Embodiments 1 to 2 and comparative Examples 1 to 5 in the present invention are compared by observation with naked eyes. The dried strawberry products obtained by Embodiments I to 2 (see FIG. 3 and FIG. 5) significantly maintain the morphology and color of the fresh strawberry to a large extent (see FIG. 2). Whereas the commercially available dried strawberry products of comparative Example 1 (FIG. 7) has a color close to that of the fresh strawberry, but has the morphology thereof changed significantly. The sample directed treated by the freeze dryer in comparative Example 2 (FIG. 9) and the sample obtained by the traditional method of freeze drying in comparative Example 3 (FIG. 11) have apparent winkles, and the samples obtained thereby cannot meet the requirement that the dried strawberry products should maintain the original morphology and color of the fresh strawberry as far as possible. The products obtained by stoving and baking in comparative Example 4 and comparative Example 5 substantially completely lose the morphology and color of the fresh strawberry (with reference to FIG. 13 and FIG. 15).

### TEST EXAMPLE 1

### Sensory Analysis Test

Sensory analysis test is systematically performed for the dried strawberry products respectively obtained in Embodiment 1 in the present invention and comparative Examples 1, 4 and 5 by using the sensory analysis test as describe above. The evaluation results are shown in the following Table 1.

TABLE 1
Result statistics of average scores of dried straw berry products
by sensory analysis test (quantity of sample: 16)

| Items for | Maintenance degree | Smell | |
|---|---|---|---|
| sensory | of the | maintenance | Taste |
| analysis | color/morphology | degree | preference |
| Embodiment 1 | 7.88 | 7.81 | 9.00 |
| (immersed by | | | |
| liquid nitrogen) | | | |
| Comparative | 5.94 | 4.00 | 8.63 |
| Example 1 | | | |
| (purchased) | | | |
| Comparative | 1.25 | 2.13 | 1.44 |
| Example 4 | | | |
| (dried by | | | |
| stoving) | | | |
| Comparative | 0.81 | 0.94 | 0.00 |
| Example 5 | | | |
| (dried by | | | |
| baking) | | | |

It is not hard to see from the table that, the maintenance degree of the color/morphology, smell and taste preference of the products obtained by storing and baking in comparative Example 4 and comparative Example 5 are all very low, and the products obtained thereby obviously become black. Whereas the results in Embodiment 1 are obviously superior to the results in comparative Example 4 and comparative Example 5. The results in Embodiment 1 are obviously superior to the compared dried products in maintenance degree of the color/morphology and smell, and are superior to or substantially equivalent to the dried products in taste preference.

The dried strawberry product of the present invention is superior to the dried strawberry product of comparative Examples 1, 4 and 5 in the aspect of sensory analysis test. The dried strawberry product (Embodiment 1) has a maintenance degree of the color/morphology at least 1.0 higher than the commercially available sample (comparative Example 1), a smell maintenance degree at least 2.0 higher than the latter, and a taste preference at least 0.4 higher than the latter.

### TEST EXAMPLE 2

### Water Content Test

The contents of water of the strawberry samples are measured according to the above method of measurement of water content, specific to the strawberry samples in Embodiment 1 and comparative Examples 1 to 5. The results are shown in the following Table 2.

TABLE 2
Water content of dried strawberry products obtained
by using different methods.

| Samples | Water content (%) |
|---|---|
| Fresh strawberry | 86.61 |
| Embodiment 1 (immersed by liquid nitrogen) | 2.10 |
| Embodiment 2 (sprayed by liquid nitrogen) | 2.18 |
| Comparative Example 1 (purchased) | 4.38 |
| Comparative Example 2 (dried directly) | 2.84 |
| Comparative Example 3 (freeze dried traditionally) | 2.65 |
| Comparative Example 4 (dried by stoving) | 1.78 |
| Comparative Example 5 (dried by baking) | 1.37 |

According to the results of Table 2, it can be seen that the dried strawberry products obtained in Embodiments 1 and 2 of the present invention have a water content equivalent to that of the dried strawberry products obtained by other traditional methods of drying, and conform to the requirement on manufacture of dried fruit and vegetable products.

### TEST EXAMPLE 3

### Water Absorption Test

The rates of water absorption of the samples in Embodiment 1 and comparative Examples 1 to 5 are respectively measured according to the above-described method of water absorption experiment and the equation for calculating the rate of water absorption. The specific results are shown in the following Table 3.

TABLE 3
Rates of water absorption of dried strawberry products
obtained by using different methods.

| Samples | m₁ (g) | m₁ (g) | F |
|---|---|---|---|
| Embodiment 1 (immersed by liquid nitrogen) | 0.62 | 2.22 | 3.58 |
| Comparative Example 1 (purchased) | 2.20 | 3.76 | 1.71 |
| Comparative Example 2 (dried directly) | 0.58 | 2.06 | 3.56 |
| Comparative Example 3 (freeze dried traditionally) | 0.70 | 2.66 | 3.80 |
| Comparative Example 4 (dried by stoving) | 0.42 | 0.63 | 1.50 |
| Comparative Example 5 (dried by baking) | 0.49 | 0.66 | 1.35 |

According to the data in Table 3, it can be seen that the dried strawberry product obtained according to the embodiment of the present invention has a good water absorption property, and can recover by absorbing water, and has a rate of water absorption F much higher than that of the samples dried by stowing and baking in comparative Example 4 and comparative Example 5, and a rate of water absorption F equivalent to that of the product obtained by traditional technique of freeze drying (comparative Example 3) and to the sample obtained by direct drying (comparative Example 2), and a rate of water absorption F also significantly higher than the traditional freeze dried strawberry commercially available (comparative Example I). Thus, the dried strawberry product provided by the present invention has a degree of drying that reaches the dry level of the traditional freeze drying technique, and an equivalent rate of water absorption.

### TEST EXAMPLE 4

### Measurement of SOD Enzyme Activity

The SOD enzyme activity of the dried strawberry products obtained in Embodiment I and Embodiment 2, the fresh strawberry block used in the embodiments, the purchased dried strawberry products and the strawberry obtained in comparative Examples 2 to 5 are measured by using the above-described method for measuring the SOD enzyme activity. The specific results are shown in the following Table 4.

TABLE 4
SOD enzyme activity of dried strawberry products
obtained by using different methods.

| | SOD enzyme activity |
|---|---|
| Samples | (U/g) on a dry weight basis |
| Strawberry of comparative Example 1 | 355.74 |
| Fresh strawberry in Embodiment 1 | 372.85 |
| Dried strawberry product of Embodiment 1 | 1118.79 |
| (immersed by liquid nitrogen) | |
| Dried strawberry product of Embodiment 1 | 872.32 |
| (sprayed by liquid nitrogen) | |
| Dried strawberry product of Comparative | 1058.05 |
| Example 2 (dried directly) | |
| Dried strawberry product of Comparative | 975.42 |
| Example 3 (freeze dried traditionally) | |
| Dried strawberry product of Comparative | 105.14 |
| Example 4 (dried by stoving) | |
| Dried strawberry product of Comparative | 92.78 |
| Example 5 (dried by baking) | |

According to results of Table 4, it can be seen that the dried strawberry products manufactured by Embodiments 1 and 2 of the present invention have a very high SOD enzyme activity, which is improved significantly as compared with the fresh strawberry blocks with the same size.

As compared with the traditional freeze dried strawberry commercially available (comparative Example 1), the dried strawberry products obtained by the method according to the present invention show a very high SOD enzyme activity; whereas the dried strawberry products dried by stoving (comparative Example 4) and dried by baking (comparative Example 5) show a very low SOD enzyme activity, which indicates that the ingredients SOD enzyme activity are severely damaged during the process of manufacturing the dried strawberry products.

The dried strawberry products obtained by the traditional freeze drying technique in comparative Example 3 also has a lower SOD enzyme activity than that of Embodiment 1.

The dried strawberry product in Embodiment 1 shows an SOD enzyme activity that is equivalent to the SOD enzyme activity of the dried strawberry product obtained by direct sublimating in comparative Example 2, which indicates that by the rapid cooling step, the SOD enzyme exhibited in the strawberry is completely retained.

In addition, in this experiment, the content of SOD enzyme of the fresh strawberry is lower than the content of SOD enzyme of treated strawberry, on a dry weight basis, which is mainly because that the substance exhibiting the SOD enzyme activity in the fresh strawberry is more difficult to be extracted, whereas the substance exhibiting the SOD enzyme activity in the dried strawberry product which is treated into a spongy state is easier to be extracted, that is to say, the substance exhibiting the SOD enzyme activity in the dried strawberry product obtained in the present invention is more likely to be utilized.

### TEST EXAMPLE 5

### Measurement of Anthocyanin Content

The contents of anthocyanin in the dried strawberry products obtained in Embodiment 1, the fresh strawberry block used in Embodiment 1 and Embodiment 2, the purchased dried strawberry products and the strawberry obtained in comparative Examples 2 to 5 are measured by using the above-described method for measuring the contents of anthocyanin. The specific results are shown in the following Table 5.

TABLE 5
Contents of anthocyanin of dried strawberry products
obtained by using different methods.

| | Anthocyanin |
|---|---|
| Samples | content (mg/100 g) |
| Fresh strawberry | 193.46 |
| Embodiment 1 (immersed by liquid nitrogen) | 244.83 |
| Embodiment 2 (sprayed by liquid nitrogen) | 241.78 |
| Comparative Example 1 (Lezi strawberry) | 124.36 |
| Comparative Example 2 (dried directly) | 221.34 |
| Comparative Example 3 (freeze dried traditionally) | 225.42 |
| Comparative Example 4 (dried by stoving) | 88.98 |
| Comparative Example 5 (dried by baking) | 95.36 |

According to the statistics of Table 5, it can be seen that the content of anthocyanin in the dried strawberry products obtained by the method according to the present invention is higher than that in comparative Examples 1 to 5. Maintenance of high anthocyanin content also indicates that the nutritional ingredients contained in the dried strawberry products of the present invention are kept well after being made into dried products. In addition, the content of anthocyanin in the dried strawberry products is also higher than that in the fresh strawberry, which is similarly inferred to be caused by difficulty to extract the anthocyanin from the fresh strawberry

### TEST EXAMPLE 6

### Comparison Between the Dried Strawberry Products Obtained by Using the Method of Embodiment I and the Method of Embodiment 2

In test Example 6, the commercially available strawberry is used to produce the dried strawberry products respectively according to the method of Embodiment 1 and the method of Embodiment 2. The contents of water, SOD enzyme activity, and contents of anthocyanin of the dried strawberry products obtained in test Example 6 are measured respectively. The results are shown in Table 6.

TABLE 6
Comparison of properties of dried strawberry products obtained
by different methods of experiment

| | Measurement result |
|---|---|
| | of content of |
| Source of strawberry and method of treatment | water (%) |
| Akihime strawberry, according to Embodiment 1 | 2.10 |
| (immersed by liquid nitrogen for 5 minutes) | |
| Akihime strawberry, according to Embodiment 2 | 2.18 |
| (sprayed by liquid nitrogen for 5 minutes) | |
| Source of strawberry and method of treatment | SOD enzyme |
| | activity (U/g), |
| | calculated on a dry |
| | weight basis |
| Akihime strawberry, according to Embodiment 1 | 1118.79 |
| (immersed by liquid nitrogen for 5 minutes) | |
| Akihime strawberry, according to Embodiment 2 | 872.32 |
| (sprayed by liquid nitrogen for 5 minutes) | |
| Source of strawberry and method of treatment | Anthocyanin |
| | content (mg/100 g), |
| | calculated on a |
| | dry weight basis |
| Akihime strawberry, according to Embodiment 1 | 244.83 |
| (immersed by liquid nitrogen for 5 minutes) | |
| Akihime strawberry, according to Embodiment 2 | 241.78 |
| (sprayed by liquid nitrogen for 5 minutes) | |

According to the results of Table 6, it can be seen that good effects can be achieved to obtain the dried strawberry products of the present invention, whether the feedstock is immersed into the liquid nitrogen, or the liquid nitrogen is sprayed onto the surface of the feedstock. In addition, the SOD enzyme activity and content of anthocyanin in the dried strawberry pieces obtained by immersion in the liquid nitrogen in Embodiment I are both higher than that of the dried strawberry products treated by spraying the liquid nitrogen on the surface in Embodiment 2. This is mainly because when the method of immersion is adopted, the fresh strawberry can be cooled much faster, and the nutritional ingredients in the strawberry can be maintained more advantageously.

### TEST EXAMPLE 7

### Comparison Between the Dried Strawberry Products Obtained by Using Different Kinds of Strawberry in Embodiment 4

In test Example 7, two different kinds of strawberry, respectively Beauty strawberry and Akihime strawberry, are selected to produce the dried strawberry products according to the method of Embodiment 1. The contents of water and SOD enzyme activity of the dried strawberry products obtained thereby are measured respectively. The results are shown in Table 7.

TABLE 7
Comparison of properties of dried strawberry products
from different sources

| Source | Content of water (%) |
|---|---|
| Beauty strawberry | 2.23 |
| Akihime strawberry | 2.10 |
| Source | SOD enzyme activity (U/g) |
| Beauty strawberry | 1217.96 |
| Akihime strawberry | 1118.79 |

According to results of Table 7, it can be seen that good effects can be achieved to different kinds of strawberry, so as to obtain the dried strawberry products of the present invention.

### TEST EXAMPLE 8

### Measurement of Chroma of Dried Strawberry Product

Specific to the strawberry product purchased from Wuqing, Tianjin, dried strawberry product are prepared by using the method described in Embodiment 1, comparative Example 2 and comparative Example 3. The outer surface chroma of the dried strawberry product obtained thereby and the dried strawberry product in comparative Example I is detected by using the method as described above. The results obtained thereby are shown in Table 8.

TABLE 8
Chroma alignment for dried strawberry products

| | Outer surface |
|---|---|
| Samples | chroma/C |
| Fresh strawberry block | 7626-7627 |
| Dried strawberry product obtained by using the method | 7626-7627 |
| of Embodiment 1 | |
| Strawberry block of comparative Example 1 | 7620-7621 |
| Dried strawberry product obtained by using the method | 7621-7622 |
| of comparative Example 2 | |
| Dried strawberry product obtained by using the method | 7625-7626 |
| of comparative Example 3 | |

According to results of Table 8, it can be seen that the outer surface chroma of the dried strawberry product obtained by using the method of the present invention is kept consistent with the outer surface chroma of the fresh strawberry; whereas all of the other methods change the color of strawberry to a certain extent.

### TEST EXAMPLE 9

### Measurement of Hardness of Dried Strawberry Product

Specific to the strawberry product purchased from Wuqing, Tianjin, dried strawberry product are prepared by using the method described in Embodiment 1, comparative Example 2 and comparative Example 3. The hardness of the dried strawberry product obtained thereby and the dried strawberry product in comparative Example 1 is detected by using the method as described above, the results obtained thereby being shown in Table 9.

TABLE 9
Hardness of dried strawberry products

| Samples | Hardness/degree |
|---|---|
| Dried strawberry product obtained by using | 12-18 |
| the method of Embodiment 1 | |
| Dried strawberry product obtained by using the | 14-22 |
| method of comparative Example 2 | |
| Dried strawberry product obtained by using the | 14-25 |
| method of comparative Example 3 | |

According to results of Table 9, it can be seen that the hardness of the dried strawberry product obtained by using the method of the present invention is lower than that of the dried strawberry product obtained by using the method of the prior art, which indicates that said dried strawberry product is more brittle with a better taste when eaten.

### TEST EXAMPLE 10

### Measurement of Warning Rate of Strawberry After Cooling

Sample Treatment:

Test Sample 1 (freeze dried traditionally): the purchased strawberry is cut into block (a cube of 0.8 cm), placed into a test machine (LGJ-10 freeze dryer, produced by Beijing Songyuan 1-Huaxing Technology Development Co., Ltd.) to be frozen, cooled to −40° C., and then taken out to measure the warming rate thereof according to the following method.

Test Sample 2 (sprayed by liquid nitrogen): the purchased strawberry is cut into block (a cube of 0.8 cm), placed on a screen mesh with liquid nitrogen sprayed thereon, for 3 minutes, transferred to a cold trap, with the temperature thereof kept stable at −40° C., and then taken out to measure the warming rate thereof according to the following method.

Test Sample 3 (immersed by liquid nitrogen): the purchased strawberry is cut into block (a cube of 0.8 cm), immersed into liquid nitrogen for 3 minutes, transferred to a cold trap, with the temperature thereof kept stable at −40° C., and then taken out to measure the warming rate thereof according to the following method.

Method for measuring the warming rate: heating the strawberry block of the above test samples at a temperature of 105° C., measuring relationship between water loss (percentage) (wherein the water loss refers to: a percentage of the reduced mass of the strawberry block due to evaporation of water during the thawing and heating process in the original mass of the strawberry) and time, with a measurement interval of 3 minutes, and a total measurement time duration of 36 minutes.

TABLE 10
Data of water loss change with time

| | Time | Water loss | | Time | Water loss | | Time | Water loss |
|---|---|---|---|---|---|---|---|---|
| Sample | (min) | (%) | Sample | (min) | (%) | Sample | (min) | (%) |
| Test | 3 | 1.32 | Test | 3 | 1.67 | Test | 3 | 2.02 |
| Sample 1 | | | Sample 2 | | | Sample 3 | | |
| | 6 | 7.72 | | 6 | 7.81 | | 6 | 8.48 |
| | 9 | 15.13 | | 9 | 16.24 | | 9 | 18.04 |
| | 12 | 21.08 | | 12 | 25.86 | | 12 | 27.15 |
| | 15 | 28.79 | | 15 | 33.01 | | 15 | 35.57 |
| | 18 | 36.24 | | 18 | 40.13 | | 18 | 42.16 |
| | 21 | 43.04 | | 21 | 46.89 | | 21 | 49.78 |
| | 24 | 49.17 | | 24 | 53.03 | | 24 | 55.76 |
| | 21 | 54.04 | | 21 | 58.98 | | 21 | 61.34 |
| | 30 | 58.19 | | 30 | 64.57 | | 30 | 66.89 |
| | 33 | 62.68 | | 33 | 69.01 | | 33 | 71.86 |
| | 36 | 66.50 | | 36 | 73.13 | | 36 | 76.03 |

Thawing rates of the three test samples measured according to the above-described method are respectively calculated by slope as follows:

Test Sample 1: 2.0347 (freeze dried traditionally)

Test Sample 2: 2.2233 (sprayed by liquid nitrogen)

Test Sample 2.2909 (immersed by liquid nitrogen)

Strawberry block immersed by liquid nitrogen>strawberry block sprayed by liquid nitrogen>strawberry block freeze dried traditionally.

It can be seen that, the strawberry block immersed by liquid nitrogen has the highest warming rate, while the strawberry block sprayed by liquid nitrogen is in the second place, and the strawberry block obtained by traditional freeze drying method has the lowest rate.

According to the description of the above embodiments and comparative examples, it is seen that for the dried strawberry product obtained by the present invention, due to short time of treatment in the whole process from the fresh food to the dried product, the dried strawberry product obtained thereby maintains the maximum degree of the original shape, color, smell, and taste, which is a dried strawberry product with high freshness. In addition, the dried strawberry product has a substantially complete internal cellular structure, a high rate of water absorption, and. meanwhile, a good degree of water absorption recovery, as well as a good chroma, and the dried strawberry product provided by the present invention is more brittle with a better taste. At the same time, as compared with the traditional freeze-drying technique, there is no need to spend a lot of time in freezing and drying, which greatly simplifies the manufacture process.

In addition, the dried strawberry product obtained in the present invention exhibits an SOD enzyme activity and the content of the nutritional ingredients such as anthocyanin significantly superior to that of other commercially available products and the samples in the comparative examples, which indicates that the method for preparing the dried strawberry product according to the present invention do not significantly damage the substances exhibiting SOD enzyme activity and the nutritional ingredients such as anthocyanin.

The preferred embodiments of the present invention are comprehensively described above, but replacement and amendment can be performed thereto. Therefore, the scope of the present invention shall not be determined with reference to the above description, instead, the scope of the present invention shall be decided according to the claims and all the equivalents. Any feature (whether being preferable or no can be combined with any other feature (whether being preferable or not). The claims of the present invention shall not be understood as a limitation of specific method t function, unless otherwise such limitation is definitely enumerated in a certain claim by the expression “method for . . . ”. The reference documents appearing in the present invention are incorporated herein as reference.

What is claimed is:

1. A dried strawberry product having* high SOD enzyme activity, wherein dried strawberry product is substantially free of moisture, has a substantially complete internal cellular structure, and exhibits a sponge appearance.

2. The dried strawberry product according to claim 1, wherein the dried strawberry product is a product prepared by cooling fresh strawberry at a rate of 20° C. or more, per minute to form moisture in the cells of the fresh strawberry into amorphous ice, and further sublimating the amorphous ice.

3. The dried strawberry product according to claim 2, wherein the cooling rate is 40° C. or more per minute.

4. The dried strawberry product according to claim 3, wherein the cooling rate is 60° C. or more per minute.

5. The dried strawberry product according to claim 4, wherein the cooling rate is 90° C. or more per minute.

6. The dried strawberry product according to claim 1, wherein the dried strawberry product has a maintenance degree of color/morphology of 7.0 or above, wherein the maintenance degree of the color/morphology of the dried strawberry product is determined by evaluation based on sensory analysis test with the color/morphology of the fresh strawberry as 10.

7. The dried strawberry product according to claim 1, wherein the dried strawberry product has a smell maintenance degree of 7.0 or above, wherein the smell maintenance degree of the dried strawberry product is determined by evaluation based on sensory analysis test with the smell of the fresh strawberry as 10.

8. The dried strawberry product according to claim 1, wherein the dried strawberry product has a taste preference of 8.0 or above, where the taste preference of the dried strawberry product is determined by evaluation based on sensory analysis test with the taste preference of the fresh strawberry as 10.

9. The dried strawberry product according to claim 1, wherein the SOD enzyme activity of the dried strawberry product is increased by 80% or more, wherein the activity is obtained by comparing the SOD enzyme activity exhibited by the dried strawberry product on a dry weight basis to the SOD enzyme activity exhibited by the feedstock of the strawberry for preparing the same on a dry weight basis.

10. The dried strawberry product according to claim 9, wherein the SOD enzyme activity is increased by 100%.

11. The dried strawberry product according to claim 1, wherein the dried strawberry product has hardness of 18 or below, as measured by using the Shore Hardness Tester.

12. The dried strawberry product according to claim 1, wherein the fresh strawberry is the fresh strawberry subjected to physical treatment.

13. A method for preparing a dried strawberry product having high SOD enzyme activities, the dried strawberry product being substantially free of moisture and having a substantially complete internal cellular structure, comprising the following steps:
a. providing a fresh strawberry;
b. cooling the fresh strawberry at a cooling rate of 20° C. or more, per minute to form moisture in the cells of the fresh strawberry into amorphous ice, and,
c. sublimating the amorphous ice in the cells of the cooled strawberry obtained from the step b to produce the dried strawberry product that is substantially free of moisture and having the substantially complete internal cellular structure.

14. The method according to claim 13, wherein the cooling is achieved by liquid nitrogen.

15. The method according to claim 13, wherein the sublimating is performed under a condition of a vacuum degree of 133 Pa or higher, preferably under a condition of a vacuum degree of from 133 Pa to 300 Pa , and the vacuum drying step is performed at a temperature of from 40 to 90° C.

16. The method according to claim 13, wherein the fresh strawberry is subjected to a physical treatment prior to step a.

17. The method according to claim 18, wherein said physical treatment is slicing said fresh strawberry into shapes comprising strawberry block, strawberry piece, strawberry dice or strawberry particles.

18. The method according to claim 13, wherein the cooling rate is 60° C. or more per minute.

19. The method according to claim 18, wherein the cooling rate is at 90° C. or more per minute.

20. A dried food product having high freshness, wherein the dried food product has a maximum radial dimension of from 0.1 to 10 cm, and the dried food product is substantially free of moisture and has a substantially complete internal cellular structure.
